(19) United States
(12) Patent Application Publication
(10) Pub. No.: US 2013/0135591 A1
(43) Pub. Date: May 30, 2013

(54) OPTICAL FIBER AND PROJECTOR DEVICE

(71) Applicants: Dongguan Masstop Liquid Crystal Display Co., Ltd, Dongguan City (CN); WINTEK CORPORATION, Taichung City (TW)

(72) Inventor: Chia-Hsiung Chang, Tainan City (TW)

(73) Assignees: WINTEK CORPORATION, Taichung City (TW); DONGGUAN MASSTOP LIQUID CRYSTAL DISPLAY CO., LTD., Dongguan City (CN)

(21) Appl. No.: 13/686,594

(22) Filed: Nov. 27, 2012

(30) Foreign Application Priority Data
Nov. 28, 2011 (TW) 100143603

(51) Int. Cl. G03B 21/14; G02B 6/00

(52) U.S. Cl. CPC G03B 21/14; G02B 6/00
USPC 353/20; 385/142; 353/31

(57) ABSTRACT

An optical fiber and a projector device are provided. The optical fiber has a main body with a light-emitting curved surface. A curvature radius of the center of the light emitting curved surface facing the main body substantially ranges between 0.05˜1 mm, so that the light emitted from the light-emitting curved surface via the main body is collimated.

This application claims the benefit of Taiwan application Serial No. 100143603, filed Nov. 28, 2011, the subject matter of which is incorporated herein by reference.

### BACKGROUND OF THE INVENTION

1. Field of the Invention

The invention relates in general to an optical element, and more particularly to an optical fiber and a projector device.

2. Description of the Related Art

The optical device such as a projector device normally adopts complicated lens design in the light source module for controlling the optical path. The disposition of the lens requires high degree of precision, otherwise the light will deflect and decrease the efficiency of the optical device or may even make the optical device unstable. Since an extra fixing element is required for disposing the lens and the lens is really an expensive element for the projector, the cost of the projector device is still very expensive now.

### SUMMARY OF THE INVENTION

The invention is directed to an optical fiber and a projector device. The optical fiber is capable of emitting a highly collimated light. The projector device replaces complicated and expensive lens with the optical fiber, so that the structure of projector device is simplified and the cost is reduced.

According to an embodiment of the present invention, an optical fiber is provided. The optical fiber has a main body with a light-emitting curved surface. A curvature radius of the center of the light emitting curved surface facing the main body substantially ranges between 0.05˜1 mm, so that the light emitted from the light-emitting curved surface via the main body is collimated.

According to another embodiment of the present invention, a projector device is provided. The projector device includes a display panel and a light source module. The display panel comprises a reflective LCD panel or a transmissive LCD panel. The light source module comprises a light emitting element, a first light processing element, a first light guide element and a second light guide element. The first light processing element includes a wavelength division multiplexer, an optical coupler or an optical splitter. The first light guide element has a light receiving end and a light outputting end opposite to the light receiving end. The light receiving end is adjacent to the light emitting element. The light outputting end is adjacent to the first light processing element. The second light guide element receives a light emitted from the first light guide element, wherein the light is transmitted to the light-emitting curved surface via the main body and is provided to the display panel.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a cross-sectional view of an optical fiber according to an embodiment;

FIG. 2 shows a cross-sectional view of an optical fiber according to an embodiment;

FIG. 3 shows a cross-sectional view of an optical fiber according to an embodiment;

FIG. 4 shows a schematic view of a projector device according to an embodiment;

FIG. 5 shows a schematic view of a projector device according to an embodiment;

FIG. 6 shows a schematic view of a projector device according to an embodiment; and

FIG. 7 shows a schematic view of a projector device according to an embodiment.

### DETAILED DESCRIPTION OF THE INVENTION

### <Optical Fiber>

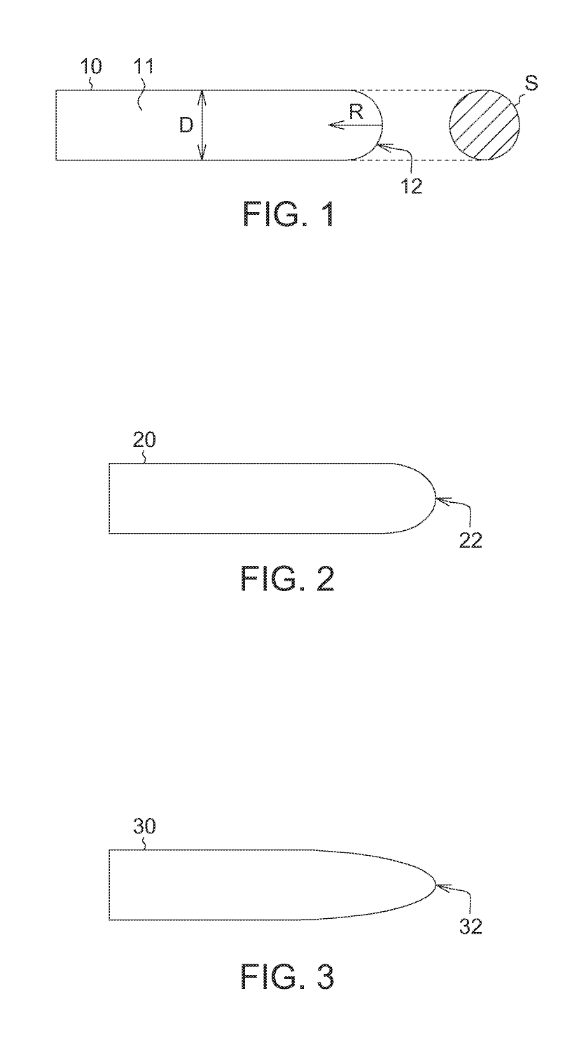

FIGS. 1˜3 respectively show a cross-sectional view of an optical fiber according to an embodiment. Referring to FIG. 1, the optical fiber 10 has a main body 11 with a semi-spherical light-emitting curved surface 12. The light-emitting curved surface 12 may be formed by way of arc discharge sintering. The diameter of the main body 11 ranges between 0.1˜2 mm. A curvature radius R of the center of the light-emitting curved surface 12 facing the main body 11 ranges between 0.05˜1 mm, so that the light emitted from the light-emitting curved surface 12 via the main body 11 is highly collimated. For example, the light emitted from the light-emitting curved surface 12 via the main body 11 after traveling along a path for 30 times of the diameter D of the main body 11 is still within the cross-section projection S of the main body.

The optical fiber of FIG. 2 is different from the optical fiber of FIG. 1 in that the light-emitting curved surface 22 of the optical fiber 20 is a semi-elliptical surface. The optical fiber of FIG. 3 is different from the optical fiber of FIG. 1 in that the light-emitting curved surface 32 of the optical fiber 30 is a parabolic surface, and other similarities are not repeated.

The optical fiber of the invention in the above embodiments, being capable of emitting a highly collimated light, is applicable to various optical devices to increase the optical efficiency. In some embodiments, the optical fiber replaces complicated and expensive lens, and further simplifies the structure of the optical device and reduces the cost. An embodiment of using the optical fiber in a projector device is exemplified below.

### <Projector Device>

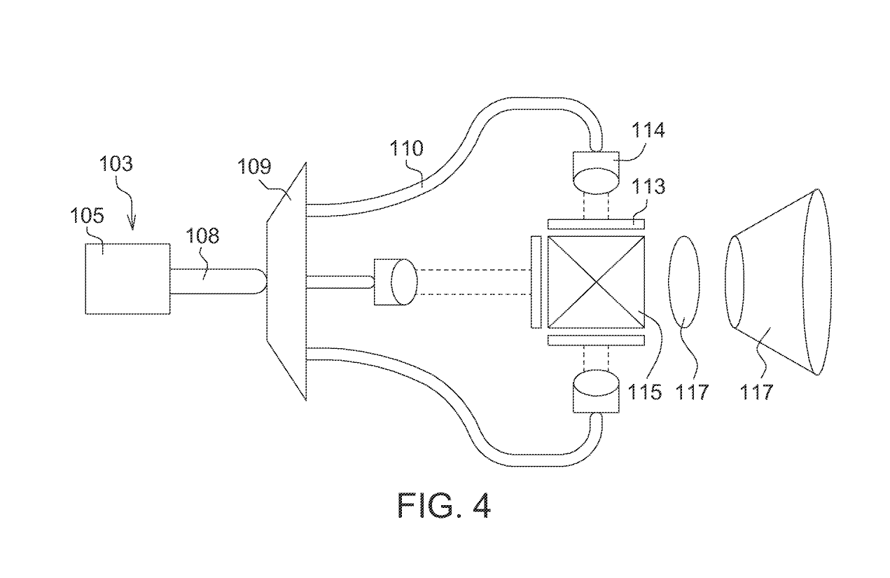

FIG. 4 shows a schematic view of a projector device according to an embodiment. Referring to FIG. 4, the projector device includes a light source module 103, a display panel 113, a polarizing beam splitter 115 and a projection lens group 117. The light source module 103 includes a light emitting element 105, a first light guide element 108, a first light processing element 109, a second light guide element 110 and a collimation lens 114.

The first light guide element 108 is used for transmitting a light emitted from the light emitting element 105 to the first light processing element 109. The second light guide element 110 receives a light emitted from the first light processing element 109, and further transmits the light towards the display panel 113.

The light emitting element 105 includes light emitting diodes such as laser diodes. In the present embodiment, the light emitting element 105 on a singe optical path is an ultra-broadband white light source, for example. The first light processing element 109 includes a wavelength division multiplexer, an optical coupler or an optical splitter. The first light guide element 108 and the second light guide element 110 both are exemplified by single-mode optical fibers, multimode optical fibers, plastic optical fibers, polarization-maintaining optical fibers, crystalline optical fibers or other suitable optical fibers.

In the present embodiment, the second light guide element 110 may be formed by an optical fiber capable of emitting a collimated light. More specifically, the diameter of the main body of the optical fiber as the second light guide element 110 ranges between 0.1˜2 mm. The curvature radius of the center of the light-emitting curved surface facing the main body ranges between 0.05˜1 mm. The light-emitting curved surface can be a semi-spherical surface, a semi-elliptical surface or a parabolic surface as indicated in FIGS. 1˜3. In some embodiments, the first light guide element 108 may also be formed by the said optical fiber capable of emitting a collimated light.

The collimation lens 114 is disposed on the light emitting side of the second light guide element 110. The collimation lens 114 makes the light emitted from the second light guide element 110 become even more collimated. In some embodiments, since the light provided by the second light guide element 110 is already highly collimated, the use of the collimation lens 114 is thus omitted.

In the present embodiment, the display panel 113 is a transmissive LCD panel. The polarizing beam splitter (PBS) 115 adjacent to the display panel 113 is used for receiving a light which is emitted from the second light guide element 110 (or the collimation lens 114) and passes through the display panel 113. The light polarized by the polarizing beam splitter 115 enters the projection lens group 117 adjacent to the polarizing beam splitter 115, and then the light is projected by the projection lens group 117 to form an image.

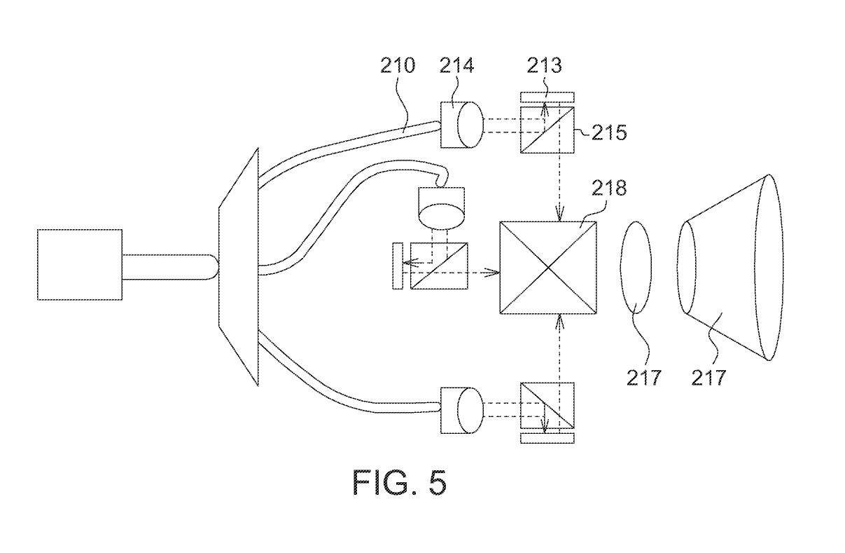

FIG. 5 shows a schematic view of a projector device according to an embodiment. The projector device of FIG. 5 is different from the projector device of FIG. 4 in that the display panel 213 is a reflective display panel. The polarizing beam splitter 215 adjacent to the second light guide element 210 (or the collimation lens 214) is used for receiving a light which is emitted from the second light guide element 210 (or the collimation lens 214) and passes through the display panel 213. The light polarized by the polarizing beam splitter 215 enters the polarizing beam splitter 218. The light reflected by the polarizing beam splitter 218 enters the projection lens group 217, and then the light is projected by the projection lens group 217 to form an image.

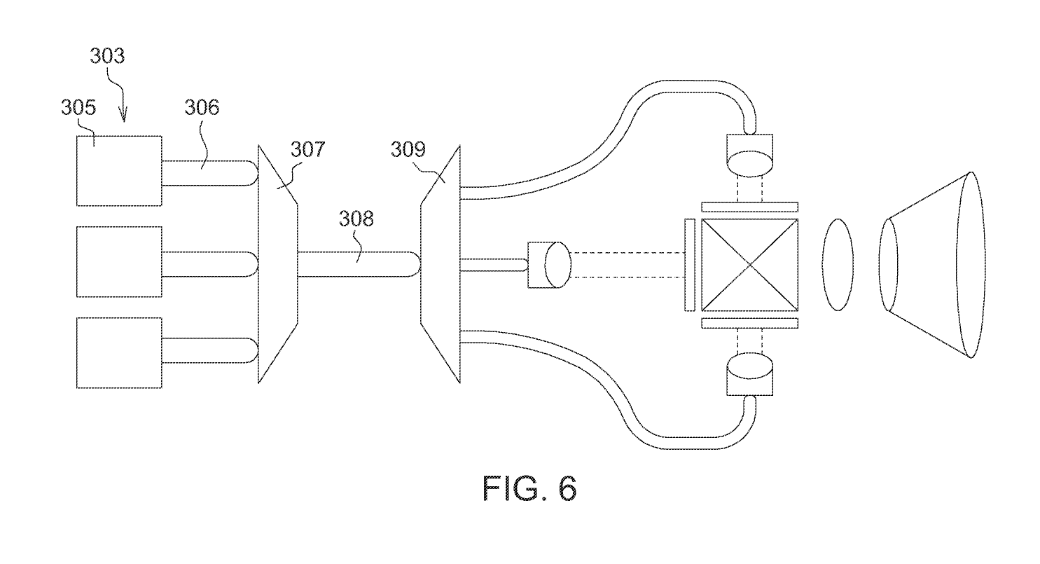

FIG. 6 shows a schematic view of a projector device according to an embodiment. The projector device of FIG. 6 is different the projector device of FIG. 4 in that the light emitting element 305 includes light emitting diodes capable of providing lights with different colors. For example, the light emitting diodes are red, green and blue laser diodes on three optical paths. The light source module 303 further includes a second light processing element 307 and a third light guide element 306. The third light guide element 306 is used for transmitting a light emitted from light emitting element 305 to the second light processing element 307. The first light guide element 308 is used for transmitting a light emitted from the second light processing element 307 to the first light processing element 309. The second light processing element 307 includes a wavelength division multiplexer, an optical coupler or an optical splitter.

The third light guide element 306 may be exemplified by a single-mode optical fiber, a multimode optical fiber, a plastic optical fiber, a polarization-maintaining optical fiber, a crystalline optical fiber or other suitable optical fiber. The third light guide element 306 may be formed by the optical fiber capable of emitting a collimated light. In details, the diameter of the main body as the optical fiber of the third light guide element 306 ranges between 0.1˜2 mm. The curvature radius of the center of the light-emitting curved surface facing the main body ranges between 0.05˜1 mm. The light-emitting curved surface can be a semi-spherical surface, a semi-elliptical surface or a parabolic surface as indicated in FIGS. 1˜3.

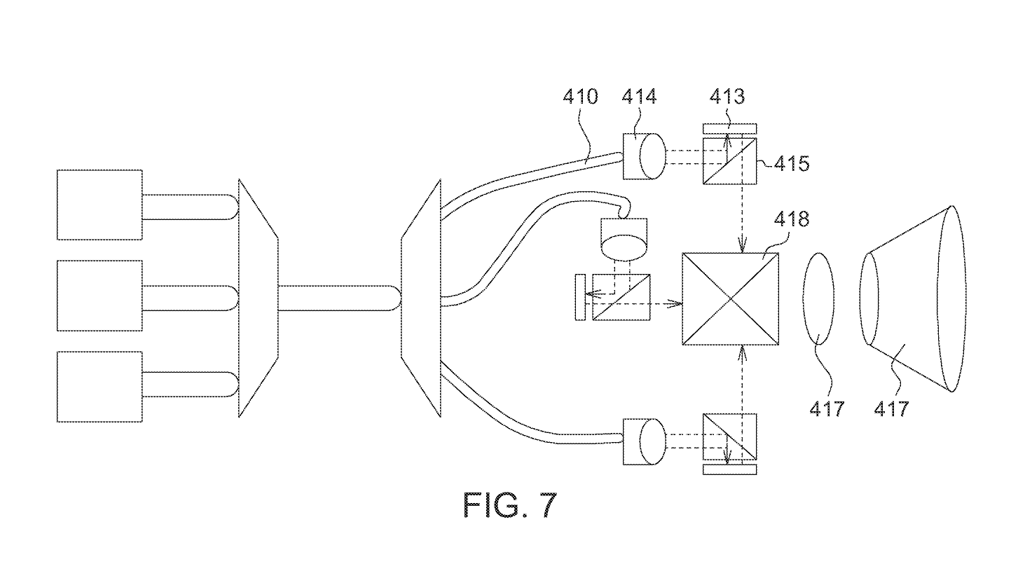

FIG. 7 shows a schematic view of a projector device according to an embodiment. The projector device of FIG. 7 is different from the projector device of FIG. 6 in that the display panel 413 is a reflective display panel. The polarizing beam splitter 415 adjacent to the second light guide element 410 (or the collimation lens 414) is used for receiving a light which is emitted from the second light guide element 410 (or the collimation lens 414) and passes through the display panel 413. The light polarized by the polarizing beam splitter 415 enters the polarizing beam splitter 418. The light reflected by the polarizing beam splitter 418 enters the projection lens group 417, and then the light is projected by the projection lens group 417 to form an image.

The optical fiber of the invention in the above embodiments, being capable of emitting a highly collimated light, is applicable to various optical devices to increase the optical efficiency. In addition, the optical fiber replaces complicated and expensive lens of an optical device, and further simplifies the structure of the optical device and reduces the cost.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An optical fiber having a main body with a light-emitting curved surface, wherein a curvature radius of a center of the light emitting curved surface facing the main body substantially ranges between 0.05˜1 mm, so that a light emitted from the light-emitting curved surface via the main body is collimated.

2. The optical fiber according to claim 1, wherein the light-emitting curved surface is a semi-spherical surface, a semi-elliptical surface or a parabolic surface.

3. The optical fiber according to claim 1, wherein the light emitted from the light-emitting curved surface via the main body after traveling along a path for 30 times of the diameter of the main body is still within a cross-section projection of the main body

4. The optical fiber according to claim 1, wherein the diameter of the main body ranges between 0.1˜2 mm.

5. A projector device comprising:
a display panel; and
a light source module comprising:
a light emitting element;
a first light processing element;
a first light guide element having a light receiving end and a light outputting end opposite to the light receiving end, wherein the light receiving end is adjacent to the light emitting element, and the light outputting end is adjacent to the first light processing element; and
a second light guide element receiving a light emitted from the first light guide element, and the light is transmitted to the light-emitting curved surface via the main body and provided to the display panel.

6. The projector device according to claim 5, wherein the light source module further comprises:
a second light processing element, wherein the first light guide element is used for transmitting a light emitted from the second light processing element to the first light processing element; and
a third light guide element for transmitting a light emitted from the light emitting element to the second light processing element.

7. The projector device according to claim 6, wherein the first light processing element comprises a wavelength division multiplexer, an optical coupler or an optical splitter; and
the second light processing element comprises a wavelength division multiplexer, an optical coupler or an optical splitter.

8. The projector device according to claim 5, wherein the first light guide element and the second light guide element are respectively formed by the optical fiber claimed in claim 1.

9. The projector device according to claim 5, wherein the first light guide element and the second light guide element are respectively formed by the optical fiber claimed in claim 2.

10. The projector device according to claim 5, wherein the first light guide element and the second light guide element are respectively formed by the optical fiber claimed in claim 3.

11. The projector device according to claim 5, wherein the first light guide element and the second light guide element are respectively formed by the optical fiber claimed in claim 4.

12. The projector device according to claim 5, wherein the light source module further comprises a collimation lens disposed adjacent to the light-emitting curved surface of the second light guide element.

13. The projector device according to claim 5, wherein the light emitting element comprises light emitting diodes.

14. The projector device according to claim 5, further comprising:
a polarizing beam splitter disposed adjacent to the display panel or the second light guide element for receiving a light emitted from the display panel or the second light guide element; and
a projection lens group disposed adjacent to the polarizing beam splitter for projecting the light emitted from the polarizing beam splitter to form an image.

15. The projector device according to claim 5, wherein the display panel comprising a reflective liquid crystal display (LCD) panel or a transmissive LCD panel.
